(19) United States
(12) Patent Application Publication
(10) Pub. No.: US 2026/0086813 A1
(43) Pub. Date: Mar. 26, 2026

(54) METHODS TO ENABLE VARIABLE-WIDTH PACKET FETCH IN COMMAND PROCESSORS

(71) Applicant: Advanced Micro Devices, Inc., Santa Clara, CA (US)

(72) Inventors: Joseph L. Greathouse, Austin, TX (US); Anthony Gutierrez, Seattle, WA (US); Mark Unruh Wyse, Seattle, WA (US); Manu Rastogi, Casselberry, FL (US); Michael Mantor, Orlando, FL (US); Alexander Fuad Ashkar, Winter Park, FL (US); Lisa Saturday, Palm Bay, FL (US)

(21) Appl. No.: 18/894,900

(22) Filed: Sep. 24, 2024

(51) Int. Cl. G06F 9/38

(52) U.S. Cl. CPC G06F 9/3856; G06F 9/3814; G06F 9/3887

(57) ABSTRACT

An apparatus and method for efficiently processing parallel data tasks. In various implementations, a computing system includes a first processing circuit and a second processing circuit that utilize a producer-consumer relationship. The first processing circuit creates a command packet for a translated kernel (function call) in a parallel data application. The first processing circuit stores the command packet in a primary queue and stores corresponding auxiliary data in a secondary queue (or auxiliary queue). The second processing circuit concurrently fetches the command packet from the primary queue and the auxiliary data from the secondary queue. The beginning storage location of the primary queue and the beginning storage location of the secondary queue are located a fixed offset from one another. This address offset is used to index concurrently into each of the work queue and the auxiliary queue. Therefore, a separate base pointer for the auxiliary queue is unnecessary.

### BACKGROUND

### Description of the Relevant Art

The parallelization of tasks is used to increase the throughput of computing systems. To this end, compilers extract parallelized tasks from applications to execute in parallel on the system hardware. Parallel data processing circuits execute multiple threads simultaneously in order to take advantage of the identified instruction-level parallelism. For example, the parallel data processing circuit includes multiple parallel lanes of execution used in a single instruction multiple data (SIMD) micro-architecture. These types of micro-architectures provide higher instruction throughput for parallel data applications than a general-purpose micro-architecture used by a host processing circuit. When executing the operating system scheduler, the host processing circuit assigns parallel data tasks to the parallel data processing circuit.

Front-end circuitry of the parallel data processing circuit fetches information prepared by the host processing circuit, and this information directs the parallel data processing circuit on how to execute the parallel data tasks. This information is typically divided into fixed-sized chunks. Many times, a parallel data task requires multiple fixed-sized chunks, but the number of chunks is unknown upfront. The front-end circuitry fetches a chunk and retrieves a pointer within the chunk that identifies a data storage location of another chunk. The front-end circuitry fetches this other chunk and this other chunk can also have a pointer that identifies a data storage location of yet another chunk. This serialized fetching performed prior to dispatch and execution of the parallel data task increases latency, which reduces performance. This serialized processing also increases the number of fetch operations, which increases memory bandwidth and power consumption.

In view of the above, methods and apparatuses for efficient processing of parallel data tasks are desired.

### BRIEF DESCRIPTION OF THE DRAWINGS

FIG. 1 is a generalized diagram of timelines as an apparatus processes parallel data tasks.

FIG. 2 is a generalized diagram of an apparatus that efficiently processes parallel data tasks.

FIG. 3 is a generalized diagram of a method for efficiently processing parallel data tasks.

FIG. 4 is a generalized diagram of an apparatus that efficiently processes parallel data tasks.

FIG. 5 is a generalized diagram of a method for efficiently processing parallel data tasks.

FIG. 6 is a generalized diagram of a computing system that efficiently processes parallel data tasks.

FIG. 7 is a generalized diagram of a method for efficiently processing parallel data tasks.

FIG. 8 is a generalized diagram of a method for efficiently processing parallel data tasks.

FIG. 9 is a generalized diagram of a method for efficiently processing parallel data tasks.

FIG. 10 is a generalized diagram of a method for efficiently processing parallel data tasks.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for efficiently processing parallel data tasks are disclosed. In various implementations, a computing system includes a first processing circuit and a second processing circuit that utilize a producer-consumer relationship. In some implementations, the first processing circuit is a host processing circuit, such as a general-purpose central processing unit (CPU), and the parallel data processing circuit is a graphics processing circuit such as a graphics processing unit (GPU). Other examples of the parallel data processing circuit are digital signal processing circuits (DSPs), field programmable gate arrays (FPGAs), application specific integrated circuits (ASICs), and so forth. The first processing circuit translates instructions of a parallel data application into commands for the second processing circuit. As used herein, the commands for the second processing circuit (parallel data processing circuit), which are translated by the first processing circuit (host processing circuit), are referred to as “translated instructions” so as not to be confused with commands in command packets stored in work queues.

After creating translated instructions of a kernel (function call), the first processing circuit generates a command packet for launching and executing the kernel. In some implementations, the command packet is an architected queuing language (AQL) packet stored in an assigned work queue such as a Heterogeneous System Architecture (HSA) queue. In various implementations, the command packet is a fixed-size packet that utilizes a function call syntax to request an operation to be performed by the second processing circuit (parallel data processing circuit). The operation can be a kernel launch or a memory data transfer. The syntax of the fixed-sized command packet includes an argument list that identifies target hardware, such as a work queue assigned to a processing circuit (e.g., second processing circuit or a subcomponent of the second processing circuit), identification of the kernel (the kernel or function call that was translated by the host processing circuit), identification of a number of dimensions in which threads (translated instructions and corresponding data items) will be created, a parameter specifying the number of threads in each dimension, identification of synchronization instructions to coordinate execution with other kernels in other command packets, a pointer specifying a beginning data storage location of auxiliary data that can't fit inside the fixed-sized command packet, and so on. The first processing circuit stores the command packet in an assigned work queue in system memory.

The first processing circuit generates or accesses the auxiliary data to be used by the second processing circuit when processing the command packet to prepare the dispatch and execution of the kernel. The first processing circuit places the auxiliary data in one or more records. As used herein, a “code object” is a data structure that stores auxiliary data used to support the dispatch and execution of a kernel. This data structure can be an Executable and Linkable Format (ELF) shared library used for parallel data operations. As used herein, the auxiliary data can also be referred to as “supplemental data,” “code object metadata” or “metadata.” As used herein, these “records” that store the code object metadata can also be referred to as “auxiliary packets” or “metadata packets” or “code object metadata packets.” Examples of the auxiliary data are an indication of the kernel (function call) name, an indication of an ELF symbol for the kernel, a string or other indication of the source code language used to define the kernel (function call), an indication of the version of the source code language, a thread block count or other indication of a total number of parallel threads for the kernel, an indication of the size of workgroups, an indication of a number of scalar registers to allocate to each wavefront, an indication of a number of vector registers to allocate to each wavefront, a kernel parameter list that includes data sizes and pointers of arguments used by the kernel, and so forth.

The first processing circuit stores the command packet in a primary queue. The first processing circuit stores the auxiliary data in a secondary queue (or auxiliary queue). When the first processing circuit has generated an indication to process the command packet, the second processing circuit fetches the command packet from the primary queue at a given point in time. The second processing circuit concurrently fetches the auxiliary data from the secondary queue at the given point in time. In various implementations, the second processing circuit includes a primary fetcher and an auxiliary fetcher (secondary fetcher) for performing the parallelized fetching at the given point in time such as a same clock cycle.

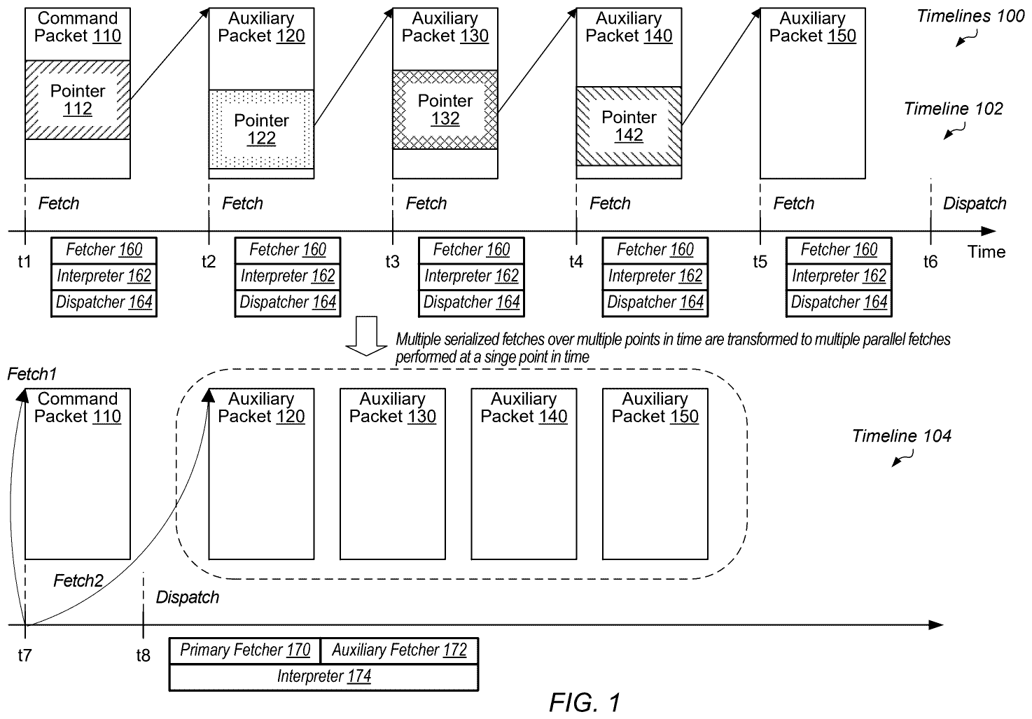

The second processing circuit processes the command packet from the primary queue using the auxiliary data stored in one or more auxiliary packets in the auxiliary queue. The parallelized fetch operations performed by the second processing circuit reduces latency, which increases performance. This parallelized fetching also reduces the number of fetch operations, which reduces memory bandwidth and power consumption. In contrast, when a pointer to the auxiliary data is stored in the command packet, the fetching operations for the command packet and the auxiliary data become serialized. The serialized fetching operations performed prior to dispatch and execution of the translated instructions of the kernel increases latency, which reduces performance. This serialized processing of the command packet and the auxiliary data also increases the number of fetch operations, which increases memory bandwidth and power consumption. To support the parallelized fetching operations, the beginning storage location of a work queue storing the command packet and the beginning storage location of an auxiliary queue storing the auxiliary data are located a fixed offset from one another. This offset is an address offset used to index concurrently into each of the work queue and the auxiliary queue. Therefore, a separate base pointer for the auxiliary queue is unnecessary. Further details of these techniques for efficiently processing parallel data tasks are provided in the following description of FIGS. 1-10.

Turning now to FIG. 1, a generalized diagram is shown of timelines 100 as an apparatus processes parallel data tasks. Timelines 100 includes timeline 102 and timeline 104. Timeline 102 illustrates serialized fetching of commands and auxiliary data. Timeline 104 illustrates parallelized fetching of commands and auxiliary data. As shown in timeline 102, the hardware, such as circuitry, of a fetcher 160 performs a fetch operation at the point in time t1 (or time t1). This fetch operation retrieves command packet 110. In some implementations, the command packet 110 is an architected queuing language (AQL) packet stored in an assigned work queue such as a Heterogeneous System Architecture (HSA) queue. In such implementations, command packet 110 is a fixed-sized packet with a size of 64 bytes and can be one of a variety of packet types of AQL packets. Examples of the packet types are kernel dispatch packets, agent dispatch packets, barrier-AND packets, barrier-OR packets, and so forth. In other implementations, other packet types are used based on design requirements.

In various implementations, command packet 110 utilizes a function call syntax to request an operation to be performed by a parallel data processing circuit that uses fetcher 160, interpreter 162 and dispatcher 164. The operation can be a kernel launch or a memory data transfer. The syntax of command packet 110 includes an argument list that identifies target hardware, such as the parallel data processing circuit or a subcomponent of the parallel data processing circuit, identification of the kernel (the kernel or function call that was translated by a host processing circuit), identification of a number of dimensions in which threads (translated instructions and corresponding data items) will be created, a parameter specifying the number of threads in each dimension, pointer 112 that specifies a data storage location that stores the beginning of auxiliary packet 120, identification of synchronization instructions to coordinate execution with other kernels in other command packets, and so on.

The host processing circuit, such as a general-purpose central processing unit (CPU), which is not shown, executes instructions of an operating system that divides the workload of an application into multiple tasks or jobs and assigns the multiple jobs to multiple different work queues associated with different processing circuits. When executing the operating system scheduler, the host processing circuit assigns parallel data tasks to a parallel data processing circuit such as a graphics processing unit (GPU). The host processing circuit translates the instructions of function calls in the application to commands recognizable by the parallel data application. These commands recognizable by the parallel data application are referred to as “translated instructions” so as not to be confused with commands in command packet 110. In the parallel data application, a program statement includes a call to launch a kernel, and the host processing circuit generates a corresponding command to perform the launch. The host processing circuit, in an implementation, inserts the command into a command packet, such as command packet 110, and stores the command packet in a ring buffer in system memory. In an implementation, the host processing circuit and the parallel data processing circuit support the Heterogeneous System Architecture (HSA) programming model that utilizes Architected Queuing Language (AQL) packets. The AQL packets are 64-byte fixed-size packets storing commands and the ring buffer is an HSA queue.

In some implementations, the circuitry of the primary fetcher 170, auxiliary fetcher 172, interpreter 174 and dispatcher (not shown) are included in a command processing circuit (or command processor) of a GPU. In other implementations, the circuitry of the primary fetcher 170, auxiliary fetcher 172, interpreter 174 and dispatcher (not shown) are included in front-end circuitry of another type of processing circuit such as a digital signal processor (DSP), a field programmable gate array (FPGA), an application specific integrated circuit (ASIC), and so forth. The hardware, such as circuitry, of interpreter 162 parses and decodes command packet 110. Interpreter 162 includes circuitry for also determining which data items are assigned to which translated instructions of workgroups and wavefronts of the kernel (function call) to be dispatched by the dispatcher 164 and then executed by hardware of the parallel data processing circuit. Interpreter 162 also uses information stored in auxiliary packets 120-150 to prepare threads for dispatch by dispatcher 164. In other implementations, the functionality of the interpreter 162 is placed within the fetcher 160 as a single functional block, rather than as two separate functional blocks as shown. Dispatcher 164 includes scheduling circuitry and arbitration circuitry to perform the dispatching of commands to processing circuitry.

As described earlier, command packet 110 also includes pointer 112 that specifies a data storage location that stores the beginning of auxiliary packet 120 (or metadata packet 120). Auxiliary packet 120 stores supplemental data used to support the execution of a kernel identified in command packet 110. Examples of the auxiliary data of auxiliary packets 120, 130, 140 and 150 are an indication of the kernel (function call) name, an indication of a Executable and Linkable Format (ELF) symbol for the kernel, a string or other indication of the source code language used to define the kernel (function call), an indication of the version of the source code language, a thread block count or other indication of a total number of parallel threads for the kernel, an indication of the size of workgroups, an indication of a number of scalar registers to allocate to each wavefront, an indication of a number of vector registers to allocate to each wavefront, a kernel parameter list that includes data sizes and pointers of arguments used by the kernel, and so forth. In various implementations, command packet 110 has a limited fixed size, and therefore, command packet 110 does not have sufficient data storage space for the auxiliary data stored in auxiliary packets 120, 130, 140 and 150.

Interpreter 162 generates an indication of a fetch request using pointer 112 based on decoding command packet 110. Interpreter 162 sends the fetch request to fetcher 160. At time t2, based on the fetch request from interpreter 162, fetcher 160 performs a fetch operation to retrieve auxiliary packet 120 based on pointer 112. Auxiliary packet 120 also includes pointer 122 that specifies a data storage location that stores the beginning of auxiliary packet 130. Auxiliary packet 130 also stores supplemental data used to support the execution of the kernel identified by command packet 110. Similar to auxiliary packet 120, auxiliary packet 130 includes further supplemental data to be used to dispatch and execute workgroups for the kernel identified by command packet 110.

Interpreter 162 generates an indication of a fetch request using pointer 122 based on decoding auxiliary data of auxiliary packet 120. Interpreter 162 sends the fetch request to fetcher 160. At time t3, fetcher 160 performs a fetch operation to retrieve auxiliary packet 130 based on pointer 122. These processing steps continue until there is no more auxiliary data to retrieve. For example, fetcher 160 performs a further fetch operation at time t4 to retrieve auxiliary packet 140 based on pointer 132 and performs a further fetch operation at time t5 to retrieve auxiliary packet 150 based on pointer 142. This serialized fetching performed prior to dispatch and execution of the translated instructions of the kernel identified by command packet 110 increases latency, which reduces performance. Dispatcher 164 dispatches the workgroups corresponding to the kernel identified by command packet 110 at time t6. This serialized fetching also increases the number of fetch operations, which increases memory bandwidth and power consumption.

As shown in timeline 104, the hardware, such as circuitry, of each of a primary fetcher 170 and an auxiliary fetcher 172 performs a fetch operation at the point in time t7 (or time t7). The first fetch operation (Fetch1) performed by primary fetcher 170 retrieves command packet 110 at time t7. The second fetch operation (Fetch2) performed by auxiliary fetcher 172 retrieves, at time t7, auxiliary packets 120, 130, 140 and 150. Therefore, interpreter 174 can parse, decode, and generate workgroups corresponding to the kernel identified by command packet 110 soon after time t7. Interpreter 174 can send this information to a dispatcher (not shown) for scheduling to processing circuitry (not shown) soon after time t7 such as at time t8. Interpreter 174 does not send any fetch requests to primary fetcher 170 or auxiliary fetcher 172. All required information in command packet 110 and auxiliary packets 120, 130, 140 and 150 have already been fetched at time t7. The parallelized fetch operations performed at time t7 prior to dispatch and execution of the translated instructions of the kernel identified by command packet 110 reduces latency, which increases performance. This parallelized fetching also reduces the number of fetch operations, which reduces memory bandwidth and power consumption.

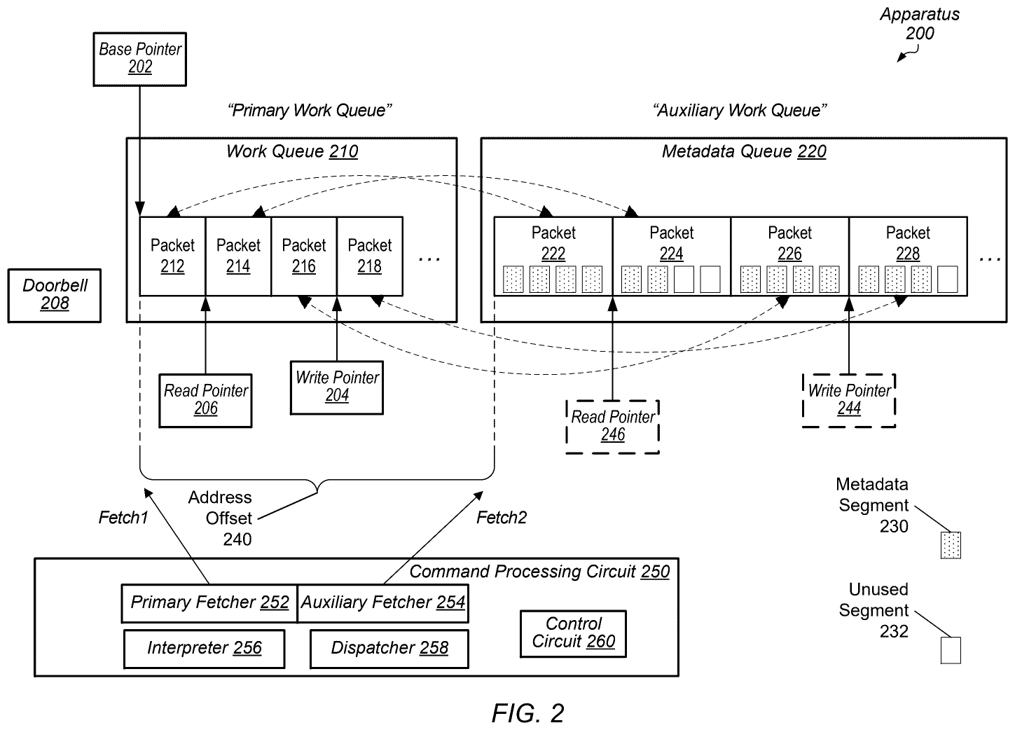

Referring to FIG. 2, a generalized diagram is shown of an apparatus 200 that efficiently processes parallel data tasks. In the illustrated implementation, work queue 210 stores multiple command packets such as command packets 212, 214, 216 and 218. Metadata queue 220 stores metadata packets 222, 224, 226 and 228. Although four command packets and four metadata packets are shown at a given point in time, another number of these packets can be stored in work queue 210 and metadata queue 220 at the given point in time as applications are processed. The command packets 212-218 store commands translated from instructions of a parallel data application by a host processing circuit executing an operating system. For example, the parallel data application includes a program statement that calls a launch of a kernel. The host processing circuit generates one of command packets 212, 214, 216 and 218 to perform the launch (dispatch and execution) of the kernel.

In various implementations, command packets 212, 214, 216 and 218 have the same syntax and functionality as command packet 110 (of FIG. 1). Therefore, command packets 212, 214, 216 and 218 support a variety of packet types such as at least kernel dispatch packets, agent dispatch packets, barrier-AND packets, barrier-OR packets, and so forth. In other implementations, other packet types are used based on design requirements. Each of the metadata packets 222-228 stores multiple metadata segments 230. In various implementations, each of the metadata segments 230 includes examples of auxiliary data used to support dispatch and execution of a kernel corresponding to command packets 212-218. Examples of auxiliary data were provided earlier for the description of auxiliary packets 120, 130, 140 and 150 (of FIG. 1).

In some implementations, the command packets 212-218 (or packets 212-218) have a fixed size of 64 bytes and the sizes of the metadata packets 222-228 also have a fixed size. In an implementation, the metadata segments 230 have a fixed size of 256 bytes. Therefore, in this implementation, the metadata packet 222 has a size of one kilobyte due to including four metadata segments 230, each with a size of 256 bytes. It is noted that the actual amount of metadata stored in metadata segment 230 that is used by a corresponding one of command packets 212-218 can vary. For example, the last used metadata segment 230 of any one of the metadata packets 222-228 can include a single byte of metadata being used or another amount less than the fixed size of 256 bytes. However, each of the metadata packets 222-228 has a fixed size regardless due to always including four fixed-size segments (metadata segment 230 or unused segment 232).

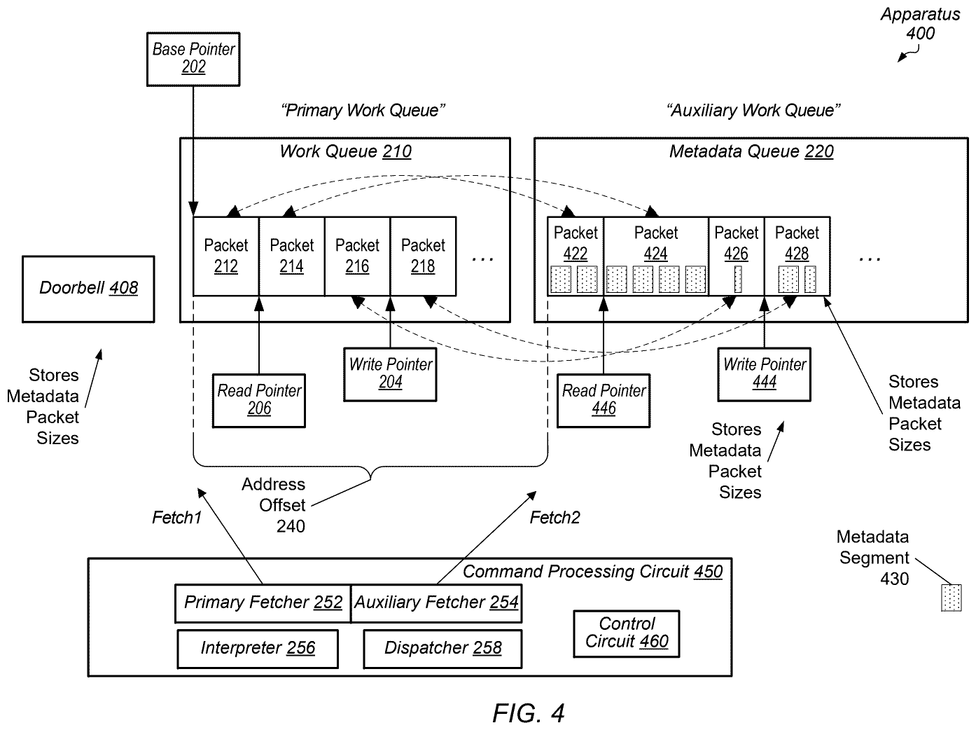

As shown, metadata packet 224 includes two metadata segments 230 that store actual metadata, but due to having a fixed size, metadata packet 224 also stores two unused segments 232. In various implementations, the first metadata segment 230 of each of the metadata packets 222-228 stores, in a header field, a total size of the actual amount of metadata in the corresponding metadata packet. Interpreter 256 decodes the header field when the metadata packets 222-228 are fetched. In other implementations, the metadata packets have varying sizes and further details of these implementations is provided in the description of apparatus 400 (of FIG. 4).

In various implementations, each of the work queue 210 and the metadata work queue 220 is a circular buffer in system memory. In an implementation, to support the producer-consumer relationship, in some implementations, the host processing circuit and the parallel data processing circuit utilize a Heterogeneous System Architecture (HSA) queue as work queue 210. Base pointer 202 is a register that stores a pointer specifying a data storage location that is the beginning of the circular buffer of work queue 210. In some implementations, the beginning storage location of work queue 210 and the beginning storage location of the metadata queue 220 are located a fixed offset from one another shown as address offset 240. Therefore, a separate base pointer for the metadata queue 220 is unnecessary.

When a producer, such as a thread being executed by the host processing circuit, writes command packets into work queue 210, the write pointer 204 is incremented. When the command packets 212 are fixed-sized packets, the producer increments write pointer 204 by a positive non-zero integer. In an implementation, this increment integer is one. When the command packets 212 are fixed-sized 64-byte packets, the increment integer of one indicates the address stored in the write pointer 204 is incremented in a manner to specify another address 64 bytes from the currently used command packet. Supporting circuitry (not shown), such as the host processing circuit, provides the wraparound update of write pointer 202 for the circular buffer implementation of work queue 210. It is noted that the producer can write multiple command packets into work queue 210 and multiple corresponding metadata packets into metadata queue 220 prior to generating an indication to process command packets (perform a write operation targeting the register 208 storing a doorbell value). The producer increments the write pointer 204 based on the number of command packets written. In an implementation, if the producer wrote five command packets into work queue 210, then the producer increments the write pointer 204 by five. Therefore, the consumer is aware that there are multiple command packets to process.

When a consumer, such as a thread being executed by the host processing circuit, reads command packets from work queue 210, the read pointer 206 is incremented. Supporting circuitry (not shown) updates the read pointer 206 in a similar manner as the write pointer 204. As described earlier, in some implementations, the beginning storage location of work queue 210 and the beginning storage location of the metadata queue 220 are located a fixed offset from one another shown as address offset 240. In various implementations, each of the command packets 212-218 in work queue 210 has a corresponding one of the metadata packets 222-228 in metadata queue 220 store auxiliary data. Therefore, a separate base pointer for the metadata queue 220 is unnecessary. For example, when a producer (e.g., a thread executing on the host processing circuit) writes commands of command packet 212 into work queue 210, the producer also writes auxiliary data (or metadata) of metadata packet 222 into metadata queue 220. Afterward, when a producer (the same producer or a different producer) writes commands of command packet 214 into work queue 210, the producer also writes auxiliary data (or metadata) of metadata packet 224 into metadata queue 220.

When the metadata packets 222-228 have a fixed size, a separate write pointer 244 and a separate read pointer 246 are unnecessary. Rather, when the metadata packets 222-228 have a fixed size, each of the incremented value of the write pointer 204, the incremented value of the read pointer 206, and the address offset 240 can be used to select one of the metadata packets 222-228 in the metadata queue 220. In various implementations, the actual total size of the metadata segments 230 of metadata packet 222 is stored in a header field of metadata packet 222. Therefore, interpreter 256 is aware of the actual needed amount of metadata in metadata packet 222 by decoding the header field. Similarly, the header fields of metadata packets 224, 226 and 228 also store respective total sizes of the actual needed amount of metadata. The metadata packets 222-228 still have fixed sizes, such as having a size of 256 bytes each, but the amount of metadata actually used by a corresponding one of the command packets 212-218 varies. However, when the metadata packets 222-228 have varying sizes, the separate write pointer 244 and the separate read pointer 246 are necessary to select the metadata packets 222-228 (or packets 222-228) in the metadata queue 220. Further details of these implementations is provided in the description of apparatus 400 (of FIG. 4).

In various implementations, the producer, and the consumer (e.g., the host processing circuit and parallel data processing circuit) perform write operations and read operations, respectively, in an atomic manner. Therefore, a first producer can write three command packets 212-216 in work queue 210 and three corresponding metadata packets 222-226 in metadata queue 220 without interruption from any other producer attempting to write data in work queue 210 or metadata queue 220. After completion of these write operations, a second producer can write command packet 218 into work queue 210 and metadata packet 228 into metadata queue 228. The first producer writes an indication into the register that stores the doorbell 208 and this indication specifies that the write operation by the first producer has completed. The use of the register that stores doorbell 208 also allows the command processing circuit 250 (consumer) to be notified that a new workload or task is ready for execution. In various implementations, command processing circuit 250 is included in a parallel data processing circuit that receives tasks prepared as command packets in work queue 210 by the host processing circuit. In such an arrangement, the threads executing on the host processing circuit are the producers and the wavefronts executing on the parallel data processing circuit are the consumers.

For the parallel data processing circuit that uses the command processing circuit 250 as front-end circuitry, a particular combination of the same translated instruction from a kernel corresponding to one of command packet 212-218 in the work queue 210 and a particular data item of multiple data items stored in a memory location identified by a pointer in auxiliary data of a corresponding one of the metadata packets 222-228 in the metadata queue 220 is referred to as a “work item.” A work item is also referred to as a thread for the parallel data processing circuit. The multiple work items (or multiple threads) are grouped into groups referred to as a “workgroup.” A workgroup includes multiple “wavefronts” or “waves.” The wavefront is a partition of work executed in an atomic manner such as by a SIMD circuit (vector processing circuit). In some implementations, a wavefront includes the translated instructions of a kernel (function call) in the parallel data application that operates on multiple data items concurrently. Each data item is processed independently of other data items, but the same sequence of operations of the subroutine (kernel or function call) is used. In an implementation, a SIMD circuit supports 64 parallel lanes of execution. Therefore, a wavefront can include 64 threads. A workgroup with four wavefronts includes 256 threads.

Command processing circuit 250 includes primary fetcher 252, auxiliary fetcher 254, interpreter 256 and dispatcher 258. In various implementations, primary fetcher 252 has the same functionality as primary fetcher 170 (of FIG. 1), auxiliary fetcher 254 has the same functionality as auxiliary fetcher 172 (of FIG. 1), interpreter 256 has the same functionality as interpreter 174 (of FIG. 1), and dispatcher 258 has the same functionality as dispatcher 164 (of FIG. 1) that includes scheduling circuitry and arbitration circuitry to perform the dispatching of commands to processing circuitry (not shown). The hardware, such as circuitry, of each of primary fetcher 252 and auxiliary fetcher 254 (or metadata fetcher 254) performs a fetch operation at the same point in time such as the same clock cycle. The first fetch operation (Fetch1) performed by primary fetcher 252 retrieves command packet 212 pointed to by read pointer 206. When the metadata packets 222-228 have a fixed size, auxiliary fetcher 254 (or metadata fetcher 254) uses the read pointer 206 and the address offset 240 to perform the second fetch operation (Fetch2) at the same point in time, such as the same clock cycle, as the first fetch operation (Fetch1) is performed.

When the metadata packets 222-228 have varying size, auxiliary fetcher 254 (or metadata fetcher 254) uses the read pointer 246 to perform the second fetch operation (Fetch2) at the same point in time, such as the same clock cycle, as the first fetch operation (Fetch1) is performed. One or more of auxiliary fetcher 254 and control circuit 260 updates the read pointer 246 based on size information for the metadata packets in metadata queue 220. Further details regarding the updating of the write pointer 244, updating the read pointer 246, and accessing metadata queue 220 when the metadata packets 222-228 have varying size is provided in the description of apparatus 400 (of FIG. 4).

The simultaneous fetching operations performed by primary fetcher 252 and auxiliary fetcher 254 allows interpreter 256 to parse, decode and assign arguments to commands and send this information to dispatcher 258 for scheduling to processing circuitry (not shown). Interpreter 256 does not send any fetch requests to primary fetcher 252 or auxiliary fetcher 254. All required information is in the retrieved command packet 212 and corresponding auxiliary packets 222. The parallelized fetch operations performed by primary fetcher 252 or auxiliary fetcher 254 reduces latency, which increases performance. This parallelized fetching also reduces the number of fetch operations, which reduces memory bandwidth and power consumption.

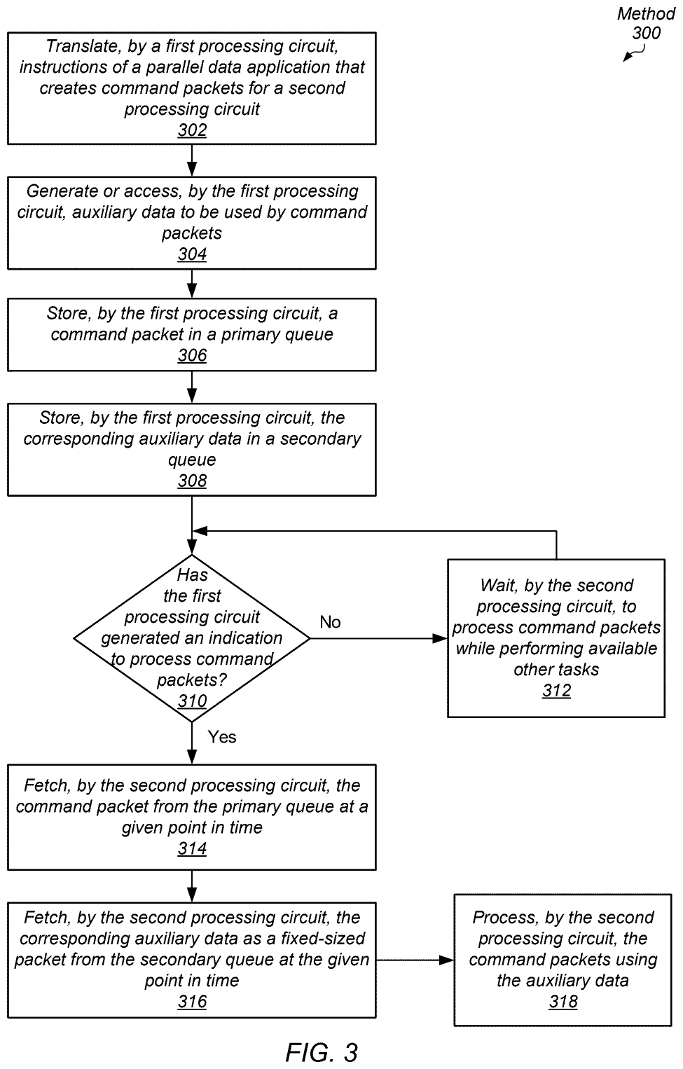

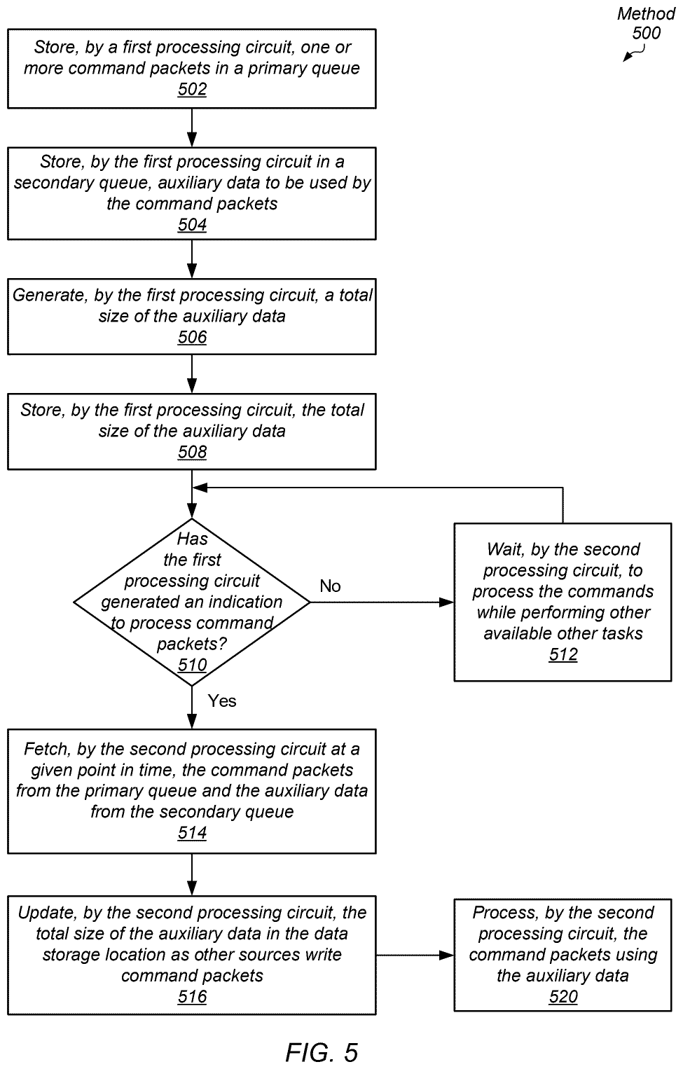

Referring to FIG. 3, a generalized diagram is shown of a method 300 for efficiently processing parallel data tasks. For purposes of discussion, the steps in this implementation (as well as in FIGS. 5 and 7-10) are shown in sequential order. However, in other implementations some steps occur in a different order than shown, some steps are performed concurrently, some steps are combined with other steps, and some steps are absent.

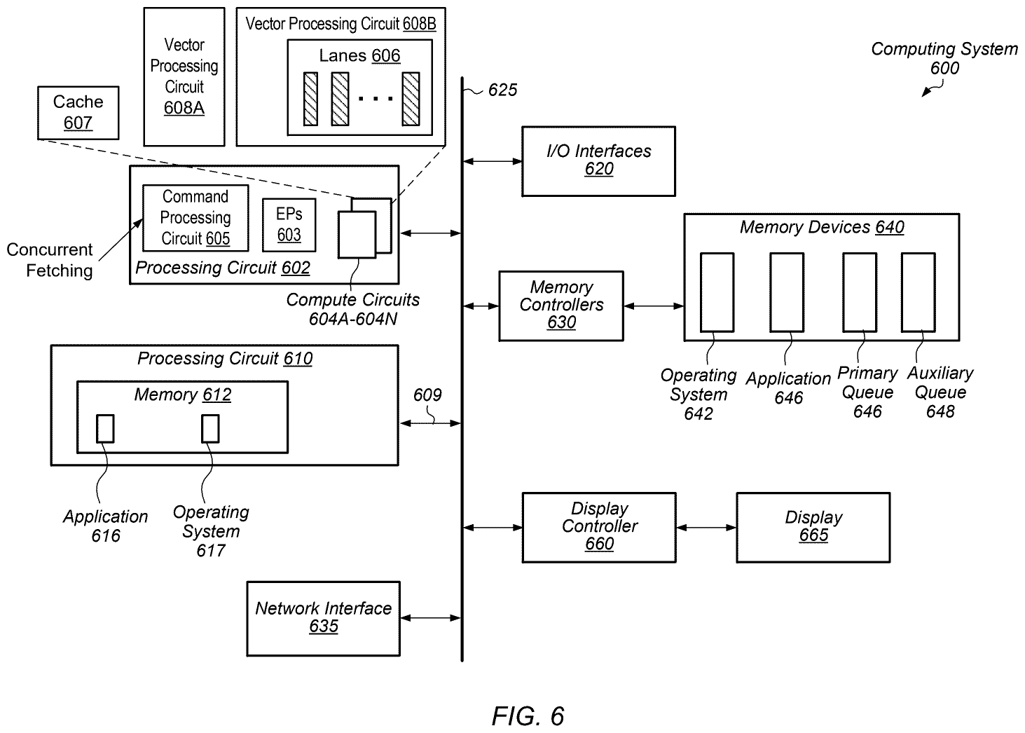

In various implementations, a computing system includes a first processing circuit and a second processing circuit. In various implementations, the first processing circuit is a host processing circuit, such as a general-purpose central processing unit (CPU). Another example of the first processing circuit is processing circuit 610 (of FIG. 6). The second processing circuit is a parallel data processing circuit such as a graphics processing unit (GPU). Other examples of the parallel data processing circuit are digital signal processing circuits (DSPs), field programmable gate arrays (FPGAs), application specific integrated circuits (ASICs), and so forth. Another example of the second processing circuit is processing circuit 602 (of FIG. 6). The first processing circuit and the second processing circuit utilize a producer-consumer relationship. The first processing circuit translates instructions of a parallel data application into commands for the second processing circuit (block 302). For example, the first processing circuit generates translated instructions from instructions of a kernel identified in a program statement of the parallel data application with the instructions of the kernel stored in a runtime library or other storage location. The first processing circuit also generates a command packet based on a kernel launch request in a program statement of the parallel data application.

The first processing circuit generates or accesses auxiliary data to be used by command packets (block 304). The first processing circuit stores a command packet in a primary queue (block 306). An example of the command packet is command packet 110 (of FIG. 1) and command packets 212-218 (of FIG. 2). In some implementations, the command packet is a fixed-sized packet with a size of 64 bytes and can be one of a variety of packet types of AQL packets. Examples of the packet types are kernel dispatch packets, agent dispatch packets, barrier-AND packets, barrier-OR packets, and so forth. In other implementations, other packet types are used based on design requirements. To support the producer-consumer relationship, in some implementations, the first processing circuit and the second processing circuit utilize a Heterogeneous System Architecture (HSA) queue as the primary queue. Examples of auxiliary data were provided earlier for the description of auxiliary packets 120, 130, 140 and 150 (of FIG. 1).

The first processing circuit stores the auxiliary data in a secondary queue (block 308). The first processing circuit stores the auxiliary data as a fixed-sized metadata packet in the secondary queue. The fixed-size metadata packet stores, in a header field, a total size of the actual amount of metadata to be used, which can be less than the size of the fixed-size metadata packet. The indication of the total size stored in the header field can specify the amount of metadata at a granularity of a byte, a word (32 bits), a double word (64 bits), or another size amount. In various implementations, the beginning storage location of the primary queue and the beginning storage location of the secondary queue are located a fixed offset from one another. An example of this offset is address offset 240 (of FIG. 2). Therefore, a separate base pointer for the secondary queue is unnecessary. If the first processing circuit has not yet generated an indication to process the command packet (“no” branch of the conditional block 310), then the second processing circuit waits to process the command packet while performing available other tasks (block 312). Afterward, control flow of method 300 returns to conditional block 310 determining whether the first processing circuit has generated an indication to process the command packet. In some implementations, to generate the indication to process the command packet, the first processing circuit performs a write operation targeting a register that stores a doorbell value.

If the first processing circuit has generated an indication to process the command packet (“yes” branch of the conditional block 310), then the second processing circuit fetches the command packet from the primary queue at a given point in time (block 314). The second processing circuit fetches the auxiliary data as fixed-sized packets from the secondary queue at the given point in time (block 316). In various implementations, the second processing circuit includes a command processing circuit with a primary fetcher and an auxiliary fetcher. Examples of the primary fetcher are primary fetcher 170 (of FIG. 1) and primary fetcher 252 (of FIG. 2). Examples of the auxiliary fetcher are auxiliary fetcher 172 (of FIG. 1) and auxiliary fetcher 254 (of FIG. 2). The second processing circuit processes the command packets using the auxiliary data (block 318).

The parallelized fetch operations performed by the second processing circuit reduces latency, which increases performance. This parallelized fetching also reduces the number of fetch operations, which reduces memory bandwidth and power consumption. It is noted that the producer can write multiple command packets into the primary queue and multiple corresponding metadata packets into the secondary queue prior to generating an indication to process command packets (perform a write operation target the register storing a doorbell value). The producer increments the write pointer by the number of command packets written. Therefore, the consumer is aware that there are multiple command packets to process.

Turning now to FIG. 4, a generalized diagram is shown of an apparatus 400 that efficiently processes parallel data tasks. Circuitry and components previously described are numbered identically. In the illustrated implementation, work queue 210 stores multiple command packets such as command packets 212, 214, 216 and 218. Metadata queue 220 stores metadata packets 422, 424, 426 and 428. Although four command packets and four metadata packets are shown, any number of these packets can be stored in work queue 210 and metadata queue 220 as applications are processed. Each of the command packets 212-218 in work queue 210 has a corresponding one of the metadata packets 422-428 stored in metadata queue 220.

Examples of auxiliary data (metadata) in metadata segments 230 were provided earlier for the description of auxiliary packets 120, 130, 140 and 150 (of FIG. 1). As shown, the metadata segments 430 have varying sizes in the metadata packets 422, 424, 426 and 428. In some implementations, one or more of the metadata packets 422-428 have a maximum size of one kilobyte due to including four metadata segments 230, each with a size of 256 bytes. In an implementation, the granularity of measuring the size of metadata packets 422, 424, 426 and 428 is the metadata segment size of 256 bytes. In such an implementation, the minimum data storage allocation size of a metadata packet is one metadata segment 430 of 256 bytes even if the actual amount of metadata to be used is less than 256 bytes.

In another implementation, the granularity of measuring the size of metadata packets 422, 424, 426 and 428 is a byte. In such an implementation, the minimum data storage allocation size of a metadata packet is one byte. Therefore, it is possible and contemplated that one or more of the metadata packets 422-428 have a minimum size of one byte due to including one metadata segment 430 with a size of one byte. It is also possible and contemplated that one or more of command packets 212-218 have no corresponding metadata packet. In other implementations, the granularity of measuring the size of metadata packets 422, 424, 426 and 428 is another amount of data based on design requirements. In various implementations, each of the variable-sized metadata packets 422-428 stores, in a header field, a total size of the actual amount of metadata to be used. The indication of the total size stored in the header field can specify the amount of metadata at a granularity of a byte, a word (32 bits), a double word (64 bits), or another size amount.

Command processing circuit 450 uses write pointer 444 and read pointer 446 to access metadata queue 220. To utilize the varying sizes of the metadata packets 422, 424, 426 and 428 and update the write pointer 444 and the read pointer 446 correctly, the corresponding sizes of metadata packets 422, 424, 426 and 428 are stored in one or more locations. As described earlier, in various implementations, each of the variable-sized metadata packets 422-428 stores, in a header field, a total size of the actual amount of metadata to be used. However, auxiliary fetcher 254 will not have this information until after fetching the variable-sized metadata packets 422-428. Therefore, one or more other locations store a total size of metadata written by a producer. As described earlier regarding apparatus 200 (of FIG. 2), it is possible and contemplated that the producer writes multiple command packets into work queue 210 and multiple corresponding metadata packets into metadata queue 220 prior to generating an indication to process command packets (perform a write operation targeting the register 408 storing a doorbell value). The producer increments the write pointer 204 based on the number of command packets written. In an implementation, if the producer wrote five command packets into work queue 210, then the producer increments the write pointer 204 by five. However, due to the metadata packets 422-428 having varying sizes, the increment amount of five does not indicate how to update write pointer 444.

To correctly update write pointer 444, the total size of the actual amount of metadata to be used for an atomic write operation of work queue 210 is stored in one or more locations. Examples of these locations are the write pointer (or write index) 444, the doorbell 408, or another storage location. For example, the write pointer (or write index) 444 and the doorbell 408 can have unused bits that can now be used to store the total size of the number of metadata packets written in metadata queue 220 during a most recent atomic write operation by a producer. As described earlier, in various implementations, the producer and the consumer (e.g., the host processing circuit and parallel data processing circuit) perform write operations and read operations, respectively, in an atomic manner. Therefore, a first producer can write three command packets 212-216 in work queue 210 and corresponding three metadata packets 422-426 in metadata queue 220 without interruption from any other producer attempting to write data in work queue 210 or metadata queue 220.

The individual sizes of individual metadata packets of the three metadata packets 422-426 are written in the header fields of the three metadata packets 422-426. After completion of these write operations, the total size of the three metadata packets 422-426 are stored in one or more of the write pointer (or write index) 444, the doorbell 408, and another storage location. When the parallel data processing circuit begins to consume the three command packets 212-216, the parallel data processing circuit uses the total size of the three metadata packets 422-426 to correctly assign the metadata of the varying sized metadata segments 230 of metadata packets 422, 424 and 426 to the command packets 212-216.

In an implementation, primary fetcher 252 fetches command packet 212 (read pointer 206 is pointing to command packet 212 at this time, rather than pointing to command packet 214 as shown). Auxiliary fetcher 254 concurrently fetches one kilobyte beginning at the start of metadata packet 222. The size of one kilobyte is based on four metadata segments having a size of 256 bytes each. However, metadata packet 422 has a size of 512 bytes due to having two metadata segments, each with a size of 256 bytes. Therefore, auxiliary fetcher 254 also fetched metadata from metadata packet 424. Interpreter 256 reads the header field of metadata packet 422 and determines that metadata packet 422 has a size of 512 bytes. A total size of metadata packets 422, 424 and 426 is 1,664 bytes due to metadata packet 422 having a size of 512 bytes, metadata packet 424 having a size of 1,024 bytes (one kilobyte) and metadata packet 426 having a size of 128 bytes. The total size is stored in unused data storage of write pointer 204, doorbell 408, or another storage location. Either interpreter 256 or control circuit 460 updates the total size from 1,664 bytes to 640 bytes (1,664 bytes-1,024 bytes). Interpreter 256 is also aware that the first 512 bytes of the 1,024 bytes (one kilobyte) of metadata for metadata packet 424 has already been fetched.

During the second fetch operation, primary fetcher 252 fetches command packet 214 (read pointer 206 is pointing to command packet 214 at this time after being updated). Auxiliary fetcher 254 concurrently fetches 640 bytes beginning in the middle of metadata packet 224. Therefore, auxiliary fetcher 254 fetches the second half (512 bytes) of metadata packet 424 and all (128 bytes) of metadata packet 426. Either interpreter 256 or control circuit 460 updates the total size from 640 bytes to 0 bytes (640 bytes-640 bytes). During the third fetch operation, primary fetcher 252 fetches command packet 216 (read pointer 206 is pointing to command packet 216 at this time after being updated). Auxiliary fetcher 254 performs no fetch operation since the required metadata has already been fetched previously.

Referring to FIG. 5, a generalized diagram is shown of a method 500 for efficiently processing parallel data tasks. For purposes of discussion, the steps in this implementation (as well as in FIGS. 3 and 7-10) are shown in sequential order. However, in other implementations some steps occur in a different order than shown, some steps are performed concurrently, some steps are combined with other steps, and some steps are absent.

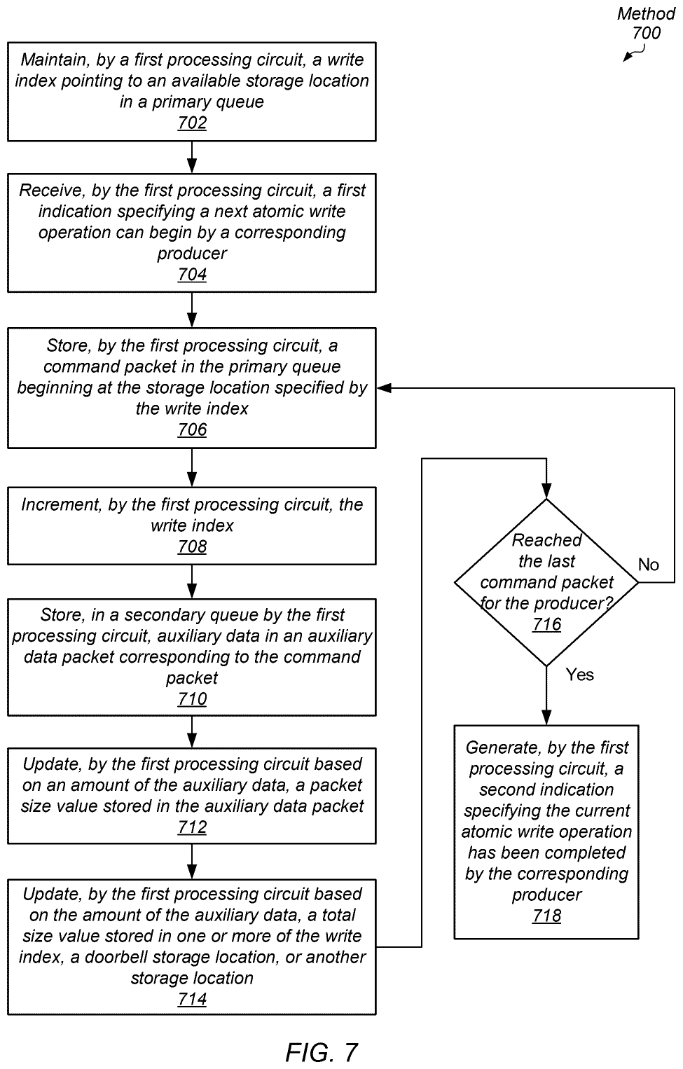

Similar to method 300 (of FIG. 3), for methods 500 and 700-1000 (of FIGS. 7-10), in various implementations, a computing system includes a first processing circuit and a second processing circuit. In various implementations, the first processing circuit is a host processing circuit, such as a general-purpose central processing unit (CPU). Another example of the first processing circuit is processing circuit 610 (of FIG. 6). The second processing circuit is a parallel data processing circuit such as a graphics processing unit (GPU). Other examples of the parallel data processing circuit are digital signal processing circuits (DSPs), field programmable gate arrays (FPGAs), application specific integrated circuits (ASICs), and so forth. Another example of the second processing circuit is processing circuit 602 (of FIG. 6). The first processing circuit and the second processing circuit utilize a producer-consumer relationship. The first processing circuit translates instructions of a parallel data application into commands for the second processing circuit. For example, the first processing circuit generates translated instructions from instructions of a kernel identified in a program statement of the parallel data application with the instructions of the kernel stored in a runtime library or other storage location. The first processing circuit also generates a command packet based on a kernel launch request in a program statement of the parallel data application. The first processing circuit stores one or more command packets in a primary queue (block 502).

The first processing circuit stores, in a secondary queue, auxiliary data to be used by the command packets as variable-sized metadata packets (block 504). The first processing circuit generates a total size of the auxiliary data (block 506). The first processing circuit stores the total size of the auxiliary data (block 508). Examples of storage locations to store the total size are the register storing the write pointer (or write index), the register storing the doorbell, or another storage location. For example, the write pointer (or write index) and the doorbell can have unused bits that can now be used to store the total size of the number of metadata packets written in the secondary queue during a most recent atomic write operation by a producer. If the first processing circuit has not yet generated an indication to process the command packets (“no” branch of the conditional block 510), then the second processing circuit waits to process the commands while performing other available other tasks (block 512). Afterward, control flow of method 500 returns to conditional block 510 where it is determined whether the first processing circuit has generated an indication to process the commands.

If the first processing circuit has generated an indication to process the command packets (“yes” branch of the conditional block 510), then the second processing circuit fetches at a given point in time the command packets from the primary queue and the auxiliary data from the secondary queue (block 514). The second processing circuit updates the total size of the auxiliary data in the data storage location as other sources (producers) write command packets (block 516). The second processing circuit processes the fetched command packets using the auxiliary data (block 518). In some implementations, a producer identifier (ID) is stored with the total size in the write pointer (write index), the doorbell, or other storage location. Therefore, the updates of the total size is performed by actions for a particular producer.

Turning now to FIG. 6, a generalized diagram is shown of a computing system 600 that efficiently processes parallel data tasks. In an implementation, computing system 600 includes at least processing circuits 602 and 610, input/output (I/O) interfaces 620, bus 625, network interface 635, memory controllers 630, memory devices 640, display controller 660, and display 665. In other implementations, computing system 600 includes other components and/or computing system 600 is arranged differently. For example, power management circuitry, and phased locked loops (PLLs) or other clock generating circuitry are not shown for ease of illustration. In various implementations, the components of the computing system 600 are on the same die such as a system-on-a-chip (SOC). In other implementations, the components are individual dies in a system-in-package (SiP) or a multi-chip module (MCM). A variety of computing devices use the computing system 600 such as a desktop computer, a laptop computer, a server computer, a tablet computer, a smartphone, a gaming device, a smartwatch, and so on.

Processing circuits 602 and 610 are representative of any number of processing circuits which are included in computing system 600. In an implementation, processing circuit 610 is a general-purpose central processing unit (CPU). In one implementation, processing circuit 602 is a parallel data processing circuit with a highly parallel data microarchitecture, such as a GPU. The processing circuit 602 can be a discrete device, such as a dedicated GPU (dGPU), or the processing circuit 602 can be integrated (an iGPU) in the same package as another processing circuit. Other parallel data processing circuits that can be included in computing system 600 include digital signal processing circuits (DSPs), field programmable gate arrays (FPGAs), application specific integrated circuits (ASICs), and so forth.

In various implementations, processing circuit 602 includes multiple, replicated compute circuits 604A-604N, each including similar circuitry and components such as the vector processing circuits 608A-608B, the cache 607, and other hardware resources (not shown) such as fixed function circuit blocks. Cache 607 can be used as a shared last-level cache in a compute circuit. Vector processing circuit 608A includes replicated circuitry of the circuitry of the vector processing circuit 608B. Although two vector processing circuits are shown, in other implementations, another number of vector processing circuits is used based on design requirements. As shown, vector processing circuit 608B includes multiple, parallel computational lanes 606. These parallel computational lanes 606 operate in lockstep. In various implementations, the data flow within each of the lanes 606 is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration.

The high parallelism offered by the hardware of the compute circuits 604A-604N is used for real-time data processing. Examples of real-time data processing are rendering multiple pixels, image blending, pixel shading, vertex shading, and geometry shading. In such cases, each of the data items of a wavefront is a pixel of an image. Compute circuits 604A-604N can also be used to execute other threads that require operating simultaneously with a relatively high number of different data elements (or data items). Examples of these threads are threads for scientific, medical, finance and encryption/decryption computations. Software development kits (SDKs) and application programming interfaces (APIs) were developed for use with widely available high-level languages to provide supported function calls to the software developer. The function calls provide an abstract layer of the parallel implementation details of the variety of types of parallel data processing circuits such as processing circuit 602. The details are hardware specific to the parallel data processing circuit 602 but hidden to the developer to allow for more flexible writing of software applications. The tasks benefiting from parallel data execution come from at least scientific, entertainment, medical and business (finance) applications.

Some of the parallel data applications use a data model such as a neural network model. When the data model is a neural network model, parameters used to characterize the data model include a number of input variables for the input layer of the neural network, an initial set of weights, a number of hidden layers, a number of nodes or neurons for each of the hidden layers, an indication of an activation function to use in each of the hidden layers, and so on. When the neural network model includes three or more hidden layers, the neural network model is considered to be using deep learning techniques. Whether the data model is using machine learning techniques or deep learning techniques, the data model is using artificial intelligence (AI) techniques by utilizing the hidden layers and training. One or more processors of servers or other computing devices train the data model using the specified parameters from the designer. When supervised learning is used, the designer also provides input vectors and desired output values to train the data model.

In some implementations, the application 646 stored on the memory devices 640 and its copy (application 616) stored on the memory 612 are a highly parallel data application that includes particular function calls using an application programming interfaces (API) to allow the developer to insert a request in the highly parallel data application for launching wavefronts of a kernel (function call). In an implementation, this kernel launch request is a C++ object, and it is converted by circuitry 618 of the processing circuit 610 to a command. Processing circuit 610 stores the commands in a ring buffer, such as primary queue 646, in the system memory provided by memory devices 640. Processing circuit 610 also stores auxiliary queue 648 in the system memory provided by memory devices 640. In various implementations, primary queue 646 is a data structure with the same functionality and data storage arrangement as work queue 210 (of FIG. 2 and FIG. 4). Auxiliary queue 648 is a data structure with the same functionality and data storage arrangement as metadata queue 220 (of FIG. 2 and FIG. 4). A parallel data processing circuit, such as processing circuit 602, reads the commands from primary queue 646 and reads the auxiliary data from auxiliary queue 648. In various implementations, the hardware of a primary fetcher and an auxiliary fetcher are included in command processing circuit (command processor) 605 of processing circuit 602.

A command indicating to launch a kernel is referred to herein as a “kernel.” A kernel mode driver of operating system 642 sends an indication to the command processing circuit of processing circuit 602 to retrieve these kernels. Each of the multiple execution pipes (EPs) 603 includes multiple work queues, each storing one of multiple assigned kernels from the multiple kernels stored in primary queue 646 in the system memory provided by memory devices 640. Each of the execution pipes 603 can also be referred to as an asynchronous compute engine (ACE) or an asynchronous compute circuit. In an implementation, asynchronous compute circuits process the tasks of a function call (kernel) stored as architected queuing language (AQL) packets in an assigned work queue, and does the processing out of order, when possible, to allow processing circuit 602 to improve utilization of its computing resources. In some implementations, command processing circuit 605 includes a pair of fetchers (e.g., primary fetcher and auxiliary fetcher) for each of the asynchronous compute engines (ACEs) or asynchronous compute circuits.

In an implementation, processing circuit 602 has eight execution pipes 603, each with eight work queues. Therefore, processing circuit 602 can have 64 separate function calls (kernels) for the vector processing circuits 608A-608B assigned simultaneously and ready for dispatch. Processing circuit 602 can have another number of separate function calls (kernels) for the DMA circuit and another number of separate function calls (kernels) for the fixed-function circuits assigned simultaneously and ready for dispatch. Therefore, processing circuit 602 can support processing more than 64 separate function calls (kernels). Asynchronous compute circuits (execution pipes 603) save context state information locally as the asynchronous compute circuits process the tasks of the assigned kernels. With the use of execution pipes 603 (and other execution pipes for DMA circuit and fixed-function circuits), less-intensive computing tasks can be processed in an overlapped manner with higher intensive computing tasks (e.g., pixel processing) to fill gaps in execution where the computing resources of processing circuit 602 would otherwise be idle.

When a kernel is assigned to a work queue of one of the execution pipes 603, a mapping operation is performed. In an implementation, the kernel mapping operations (or mapping operations) assign a memory queue descriptor (MQD) of the kernel stored in system memory (primary queue 646 in system memory) to a work queue of an execution pipe (one of EPs 603) identified by a hardware queue descriptor (HQD). Other identifiers besides the MQD of the kernel and the HQD of the work queue are possible and contemplated in other implementations to assign (map) the kernel to the work queue.

Memory 612 represents a local hierarchical cache memory subsystem. Memory 612 stores source data, intermediate results data, results data, and copies of data and instructions stored in memory devices 640. Processing circuit 610 is coupled to bus 625 via interface 609. Processing circuit 610 receives, via interface 609, copies of various data and instructions, such as the operating system 642, one or more device drivers, one or more applications such as application 646, and/or other data and instructions. The processing circuit 610 retrieves a copy of the application 646 from the memory devices 640, and the processing circuit 610 stores this copy as application 616 in memory 612.

In some implementations, computing system 600 utilizes a communication fabric (“fabric”), rather than the bus 625, for transferring requests, responses, and messages between the processing circuits 602 and 610, the I/O interfaces 620, the memory controllers 630, the network interface 635, and the display controller 660. When messages include requests for obtaining targeted data, the circuitry of interfaces within the components of computing system 600 translates target addresses of requested data. In some implementations, the bus 625, or a fabric, includes circuitry for supporting communication, data transmission, network protocols, address formats, interface signals and synchronous/asynchronous clock domain usage for routing data.

Memory controllers 630 are representative of any number and type of memory controllers accessible by processing circuits 602 and 610. While memory controllers 630 are shown as being separate from processing circuits 602 and 610, it should be understood that this merely represents one possible implementation. In other implementations, one of memory controllers 630 is embedded within one or more of processing circuits 602 and 610 or it is located on the same semiconductor die as one or more of processing circuits 602 and 610. Memory controllers 630 are coupled to any number and type of memory devices 640.

Memory devices 640 are representative of any number and type of memory devices. For example, the type of memory in memory devices 640 includes Dynamic Random Access Memory (DRAM), Static Random Access Memory (SRAM), NAND Flash memory, NOR flash memory, Ferroelectric Random Access Memory (FeRAM), or otherwise. Memory devices 640 store at least instructions of an operating system 642, one or more device drivers, and application 646. In some implementations, application 446 is a highly parallel data application such as a video graphics application, a shader application, or other. Copies of these instructions can be stored in a memory or cache device local to processing circuit 610 and/or processing circuit 602.

I/O interfaces 620 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB). Various types of peripheral devices (not shown) are coupled to I/O interfaces 620. Such peripheral devices include (but are not limited to) displays, keyboards, mice, printers, scanners, joysticks or other types of game controllers, media recording devices, external storage devices, and so forth. Network interface 635 receives and sends network messages across a network.

Referring to FIG. 7, a generalized diagram is shown of a method 700 for efficiently processing parallel data tasks. For purposes of discussion, the steps in this implementation (as well as in FIGS. 3 and 8-10) are shown in sequential order. However, in other implementations some steps occur in a different order than shown, some steps are performed concurrently, some steps are combined with other steps, and some steps are absent.

Similar to method 500 (of FIG. 5), for methods 700-1000 (of FIGS. 7-10) a computing system uses a first processing circuit and a second processing circuit that utilize a producer-consumer relationship. Processing circuit 610 (of FIG. 6) is an example of the first processing circuit. Processing circuit 602 (of FIG. 6) is an example of the second processing circuit. The second processing circuit includes a command processing circuit with a primary fetcher and an auxiliary fetcher. Examples of the primary fetcher are primary fetcher 170 (of FIG. 1) and primary fetcher 252 (of FIG. 2). Examples of the auxiliary fetcher are auxiliary fetcher 172 (of FIG. 1) and auxiliary fetcher 254 (of FIG. 2). The first processing circuit maintains a write index (or write pointer) pointing to an available storage location in a primary queue (block 702). The first processing circuit receives a first indication specifying a next atomic write operation can begin by a corresponding producer (block 704). The first processing circuit stores a command packet in the primary queue beginning at the storage location specified by the write index (block 706). The first processing circuit increments the write index (block 708).

The first processing circuit stores, in a secondary queue, auxiliary data in an auxiliary data packet corresponding to the command packet (block 710). Based on an amount of the auxiliary data, the first processing circuit updates a packet size value stored in the auxiliary data packet (block 712). For example, the header field is updated with the packet size. Based on the amount of the auxiliary data, the first processing circuit updates a total size value stored in one or more of the write index, a doorbell storage location, or another storage location (block 714). If the producer has not yet reached the last command packet (“no” branch of the conditional block 716), then control flow of method 700 returns to block 706 where the first processing circuit stores a command packet in the primary queue beginning at the storage location specified by the write index. If the producer has reached the last command (“yes” branch of the conditional block 716), then the first processing circuit generates a second indication specifying the current atomic write operation has been completed by the corresponding producer (block 718).

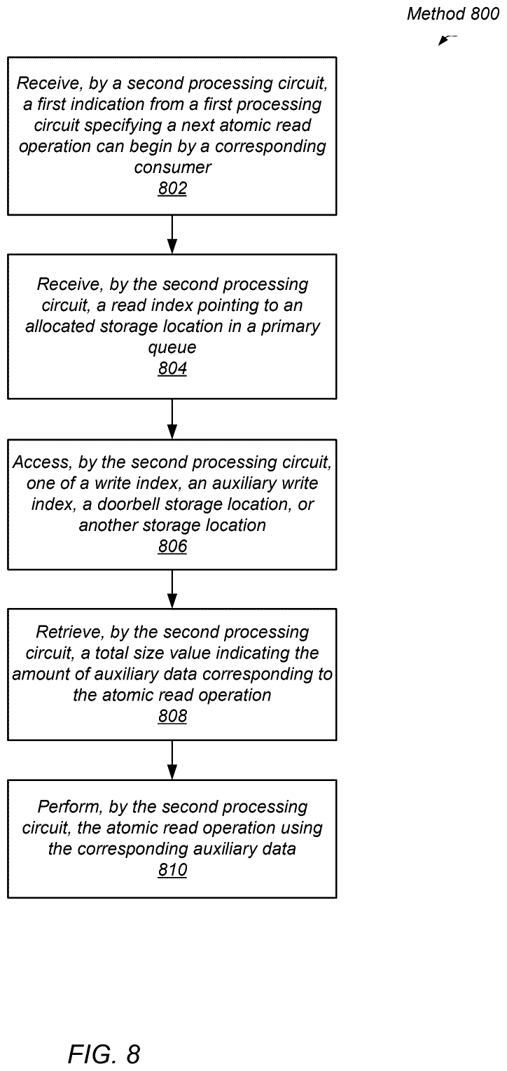

Turning now to FIG. 8, a generalized diagram is shown of a method 800 for efficiently processing parallel data tasks. The second processing circuit receives a first indication from a first processing circuit specifying a next atomic read operation can begin by a corresponding consumer (block 802). The second processing circuit receives a read index (or read pointer) pointing to an allocated storage location in a primary queue (block 804). The second processing circuit accesses one of a write index, an auxiliary write index, a doorbell storage location, or another storage location (block 806). The second processing circuit retrieves a total size value indicating the amount of auxiliary data corresponding to the atomic read operation (block 808). The second processing circuit performs the atomic read operation using the corresponding auxiliary data (block 810).

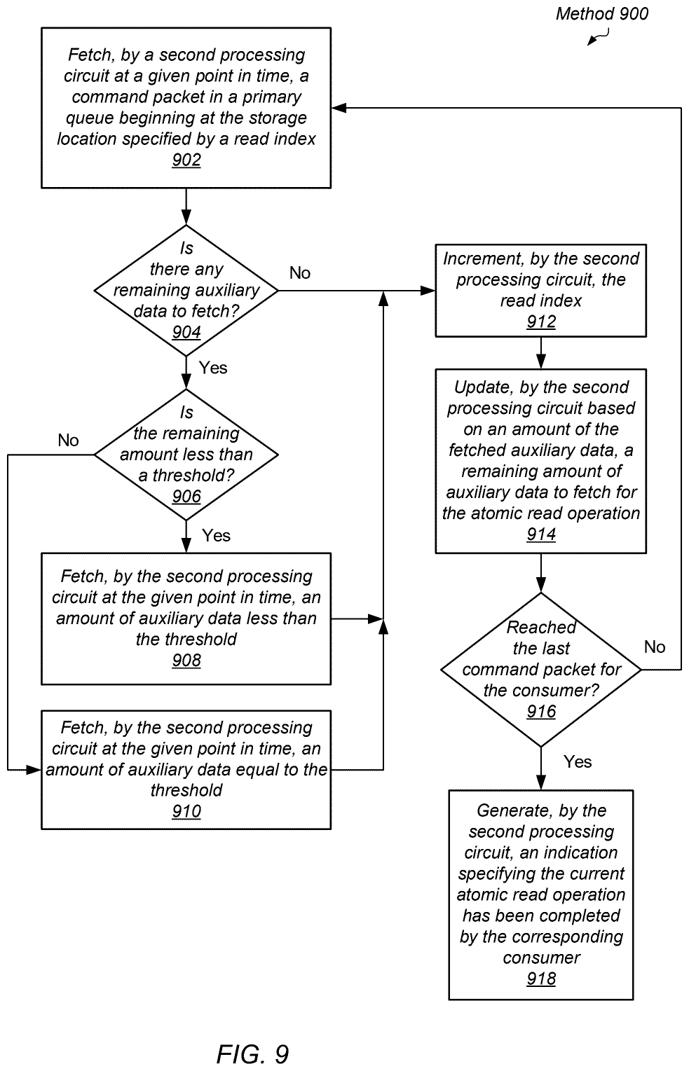

Referring to FIG. 9, a generalized diagram is shown of a method 900 for efficiently processing parallel data tasks. The second processing circuit fetches, at a given point in time, commands of a command packet in a primary queue beginning at the storage location specified by a read index (block 902). If there is any remaining auxiliary data to fetch (“yes” branch of the conditional block 904), and if the remaining amount of auxiliary data is less than a threshold (“yes” branch of the conditional block 906), then the second processing circuit fetches, at the given point in time, an amount of auxiliary data less than the threshold (block 908). Afterward, the second processing circuit increments the read index (block 912).

If there is any remaining auxiliary data to fetch (“yes” branch of the conditional block 904), and if the remaining amount of auxiliary data is equal to or greater than the threshold (“no” branch of the conditional block 906), then the second processing circuit fetches, at the given point in time, an amount of auxiliary data equal to the threshold (block 910). Afterward, the second processing circuit increments the read index (block 912). If there is no remaining auxiliary data to fetch (“no” branch of the conditional block 904), then the second processing circuit increments the read index (block 912).

After the second processing circuit increments the read index (block 912), the second processing circuit updates, based on an amount of the fetched auxiliary data, a remaining amount of auxiliary data to fetch for the atomic read operation (block 914). If the consumer has not yet reached the last command packet (“no” branch of the conditional block 916), then control flow of method 900 returns to block 902 where the second processing circuit fetches, at the given point in time, commands of a command packet in a primary queue beginning at the storage location specified by a read index. If the consumer has reached the last command packet (“yes” branch of the conditional block 916), then the second processing circuit generates an indication specifying the current atomic read operation has been completed by the corresponding consumer (block 918).

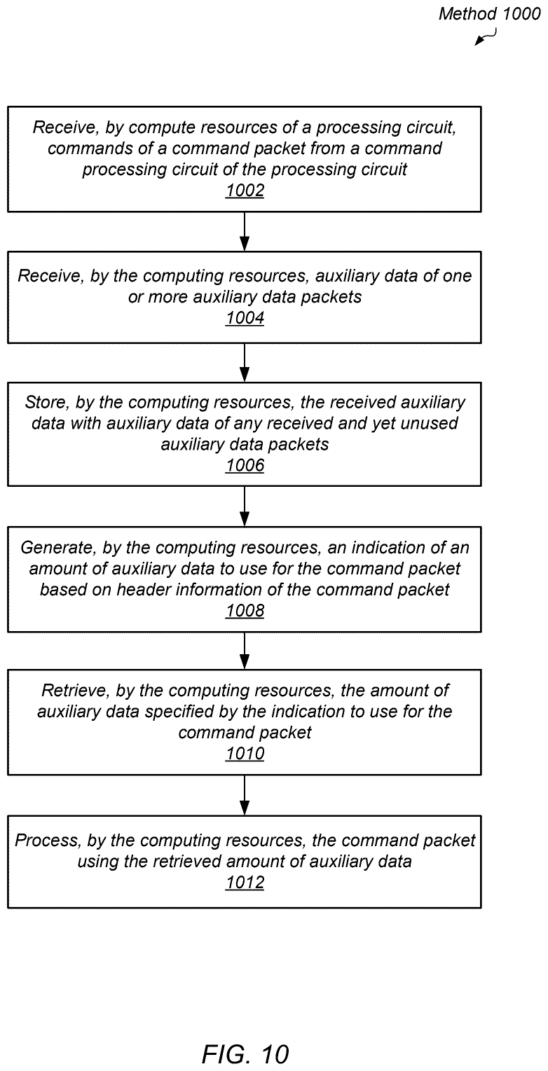

Turning now to FIG. 10, a generalized diagram is shown of a method 1000 for efficiently processing parallel data tasks. Compute resources of a processing circuit receive commands of a command packet from a command processing circuit of the processing circuit (block 1002). The computing resources receive auxiliary data of one or more auxiliary data packets (block 1004). The computing resources store the received auxiliary data with auxiliary data of any received and yet unused auxiliary data packets (block 1006). The computing resources generate an indication of an amount of auxiliary data to use for the command packet based on header information of the command packet (block 1008). The computing resources retrieve the amount of auxiliary data specified by the indication to use for the command packet (block 1010). The computing resources process the command packet using the retrieved amount of auxiliary data (block 1012).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware-based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is

1. An apparatus comprising:
circuitry configured to:
responsive to an indication that one or more command packets are ready to be processed:
fetch at least one command packet from a primary queue and at least one auxiliary data packet from a secondary queue; and
process commands of the at least one command packet using auxiliary data of the at least one auxiliary data packet.

2. The apparatus as recited in claim 1, wherein each of the first queue and the second queue is a circular buffer storing data in a contiguous manner.

3. The apparatus as recited in claim 2, wherein:
each of the command packets has a first fixed size and each of the auxiliary data packets has a second fixed size; and
a beginning of the second queue is located a fixed offset from a beginning of the first queue.

4. The apparatus as recited in claim 1, wherein:
each of the command packets comprises commands generated by a host processing circuit; and
one or more of the auxiliary data packets comprises data items used as function call arguments by commands of a corresponding command packet.

5. The apparatus as recited in claim 2, wherein:
one or more of the auxiliary data packets has a variable size; and
each of the first queue and the second queue has a respective write index and read index.

6. The apparatus as recited in claim 5, wherein the circuitry is configured to retrieve, from a memory register, a total size of auxiliary data to be used by the one or more command packets generated by a host processing circuit during an atomic write operation.

7. The apparatus as recited in claim 6, wherein the circuitry is configured to:
fetch an amount of auxiliary data equal to a threshold, responsive to a remaining amount of auxiliary data for the one or more command packets being equal to or greater than the threshold; and
fetch an amount of auxiliary data less than the threshold, responsive to the remaining amount of auxiliary data for the one or more command packets being less than the threshold.

8. A method, comprising:
storing, by a first processing circuit, command packets in a primary queue;
responsive to an indication that one or more command packets are ready to be processed:
fetching, by a second processing circuit, at least one command packet from the primary queue and at least one auxiliary data packet from a secondary queue in the memory; and
processing, by the second processing circuit, commands of the at least one command packet using auxiliary data of the at least one auxiliary data packet.

9. The method as recited in claim 8, further comprising storing, by the first processing circuit, data in a contiguous manner in a circular buffer in each of the first queue and the second queue.

10. The method as recited in claim 9, wherein:
each of the command packets has a first fixed size and each of the auxiliary data packets has a second fixed size; and
a beginning of the second queue is located a fixed offset from a beginning of the first queue.

11. The method as recited in claim 8, wherein:
each of the command packets comprises commands generated by a host processing circuit; and
one or more of the auxiliary data packets comprises data items used as function call arguments by commands of a corresponding command packet.

12. The method as recited in claim 9, wherein:
one or more of the auxiliary data packets has a variable size; and
each of the first queue and the second queue has a respective write index and read index.

13. The method as recited in claim 12, further comprising retrieving, from a memory register by the second processing circuit, a total size of auxiliary data to be used by the one or more command packets generated by a host processing circuit during an atomic write operation.

14. The method as recited in claim 13, further comprising:
fetching, by the second processing circuit, an amount of auxiliary data equal to a threshold, responsive to a remaining amount of auxiliary data for the one or more command packets is equal to or greater than the threshold; and
fetching, by the second processing circuit, an amount of auxiliary data less than the threshold, responsive to the remaining amount of auxiliary data for the one or more command packets is less than the threshold.

15. A computing system comprising:
a memory; and
a plurality of processing circuits;
wherein a first processing circuit of the plurality of processing circuits is configured to store command packets in a primary queue in the memory; and
wherein responsive to an indication that one or more command packets are ready to be processed, a second processing circuit of the plurality of processing circuits is configured to:
fetch at least one command packet from the primary queue and at least one auxiliary data packet from a secondary queue in the memory; and
process commands of the at least one command packet using auxiliary data of the at least one auxiliary data packet.

16. The computing system as recited in claim 15, wherein each of the first queue and the second queue is a circular buffer storing data in a contiguous manner.

17. The computing system as recited in claim 16, wherein:
each of the command packets has a first fixed size and each of the auxiliary data packets has a second fixed size; and
a beginning of the second queue is located a fixed offset from a beginning of the first queue.

18. The computing system as recited in claim 15, wherein:
each of the command packets comprises commands generated by a host processing circuit for processing by the apparatus; and
one or more of the auxiliary data packets comprises data items used as function call arguments by commands of a corresponding command packet.

19. The computing system as recited in claim 16, wherein:
one or more of the auxiliary data packets has a variable size; and
each of the first queue and the second queue has a respective write index and read index.

20. The computing system as recited in claim 19, wherein the second processing circuit is configured to retrieve, from a memory register, a total size of auxiliary data to be used by the one or more command packets generated by a host processing circuit during an atomic write operation.
